(19) United States
(12) Patent Application Publication
(10) Pub. No.: US 2007/0115249 A1
(43) Pub. Date: May 24, 2007

(54) Embedded location codes for e-brush position determination

(75) Inventors: Murray Gillies, Veldhoven (NL); Mark T. Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/583,400

(22) PCT Filed: Dec. 13, 2004
(86) PCT No.: PCT/IB04/52795

§ 371 Date: Jun. 16, 2006

Related U.S. Application Data
(60) Provisional application No. 60/530,159, filed on Dec. 17, 2003.

(51) Int. Cl. G09G 3/34

(52) U.S. Cl. 345/107

(57) ABSTRACT

An electronic ink stack (70) employs a pair of electrodes (71, 74, 78), an electronic ink layer (73), and an optional photoconductor layer (72, 76). The electronic ink layer (73) and the photoconductor layer (72, 76), if employed, are disposed between the electrodes (71, 74, 78). One or more location codes (75, 76, 79) are embedded within the electronic ink stack (70) in one or both electrodes (71, 74, 78), and/or the photoconductor layer (72, 76), if employed.

The present invention generally relates to electrophoretic displays. The present invention specifically relates to location codes for writing an E-ink image onto electrophoretic display.

Electronic ink or E-ink as known in the art is formed from capsules that contain black negatively charged particles and white positively charged particles. In an electrophoretic display, the capsules are typically disposed between a pair of electrodes whereby an application of a voltage of a particular polarity can switch the system between black and white. Some known electrophoretic displays are optically addressable via an incorporation of a photoconductor layer between the electrodes. Upon illumination from a scanning laser beam, the photoconductor becomes a conductor and the E-ink can be switched between black and white via a voltage pulse. The combination of E-ink and photoconductor is known in the art as E-paint, and a hand held device known as an E-brush houses the illumination source.

In order to achieve a desired image in the E-ink, it is imperative that an E-brush has the capability of accurately determining its position relative to the E-ink. The present invention advances the art by providing an electronic ink stack employing a front electrode, a back electrode, an optical photoconductor layer, an electronic ink layer, and one or more location codes. The electronic ink layer is disposed between the front electrode and the back electrode. When employed, the photoconductor is also disposed between the front electrode and the back electrode. The location code(s) are embedded within the front electrode, the back electrode, and/or the photoconductor layer (if employed).

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

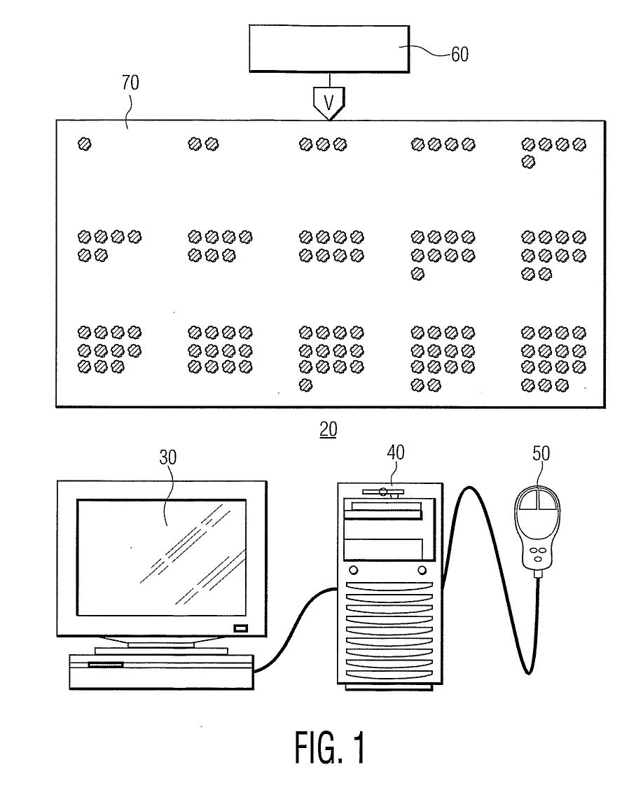

FIG. 1 illustrates one embodiment of an electronic paint system in accordance with the present invention;

FIG. 2 illustrates an exploded view of a first embodiment of an E-ink stack in accordance with the present invention;

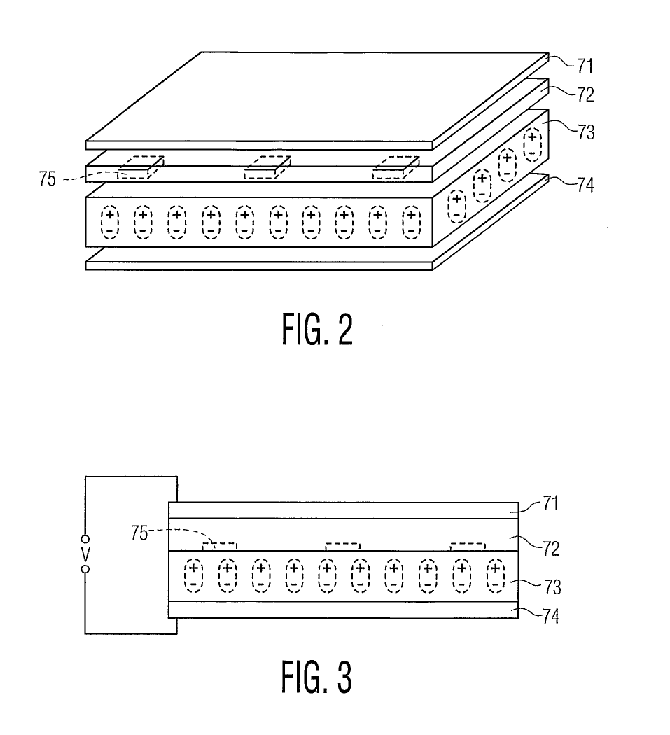

FIG. 3 illustrates a side view of the E-ink stack illustrated in FIG. 2;

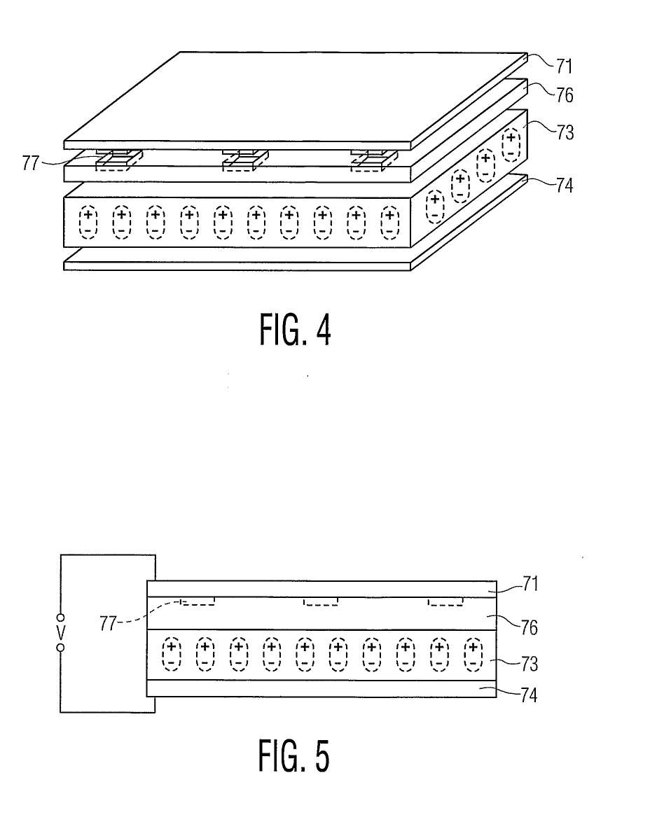

FIG. 4 illustrates an exploded view of a first embodiment of an E-ink stack in accordance with the present invention;

FIG. 5 illustrates a side view of the E-ink stack illustrated in FIG. 4;

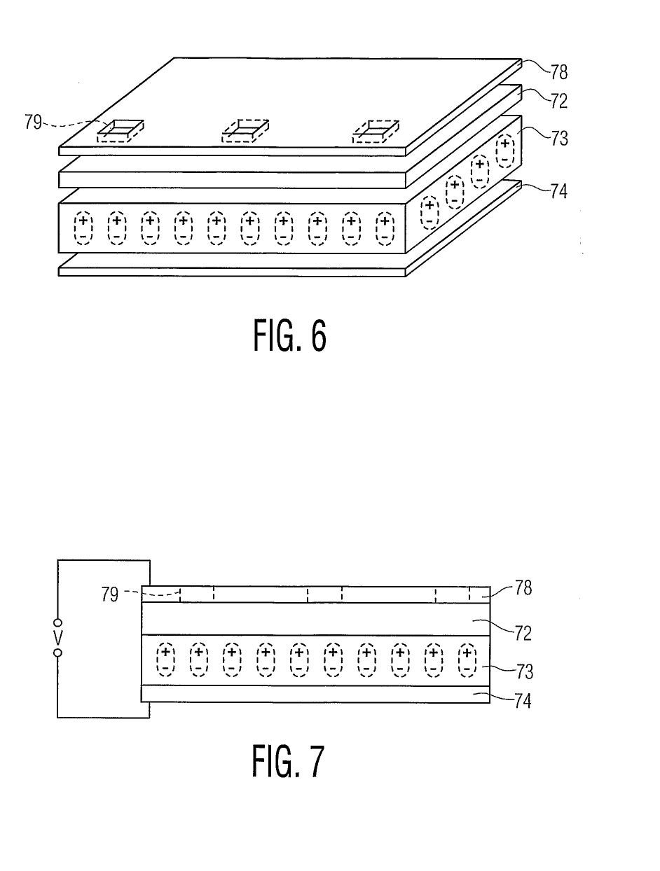

FIG. 6 illustrates an exploded view of a first embodiment of an E-ink stack in accordance with the present invention;

FIG. 7 illustrates a side view of the E-ink stack illustrated in FIG. 6;

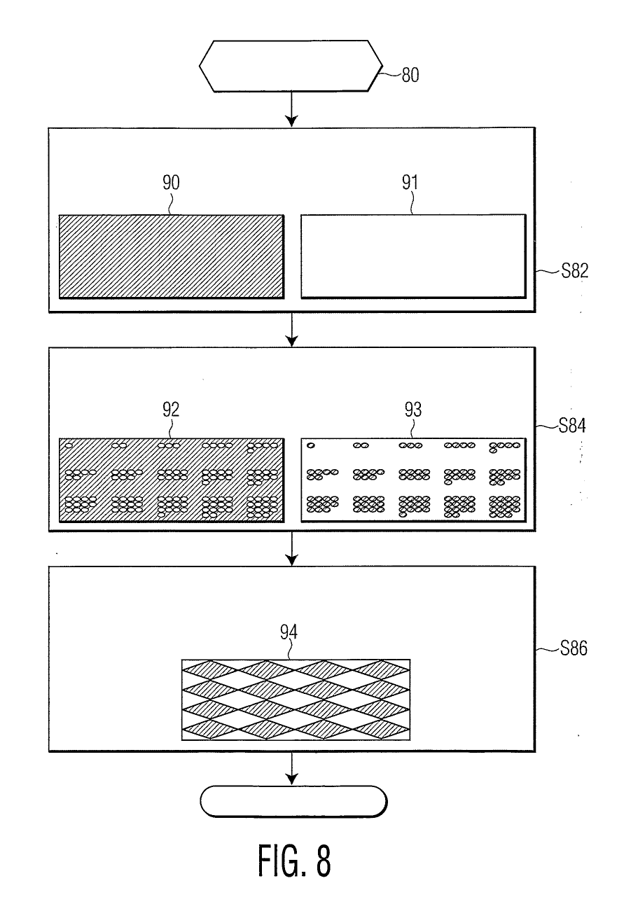

FIG. 8 illustrates a flow chart representative of a method of providing various images in the E-ink stacks illustrated in FIGS. 2-7;

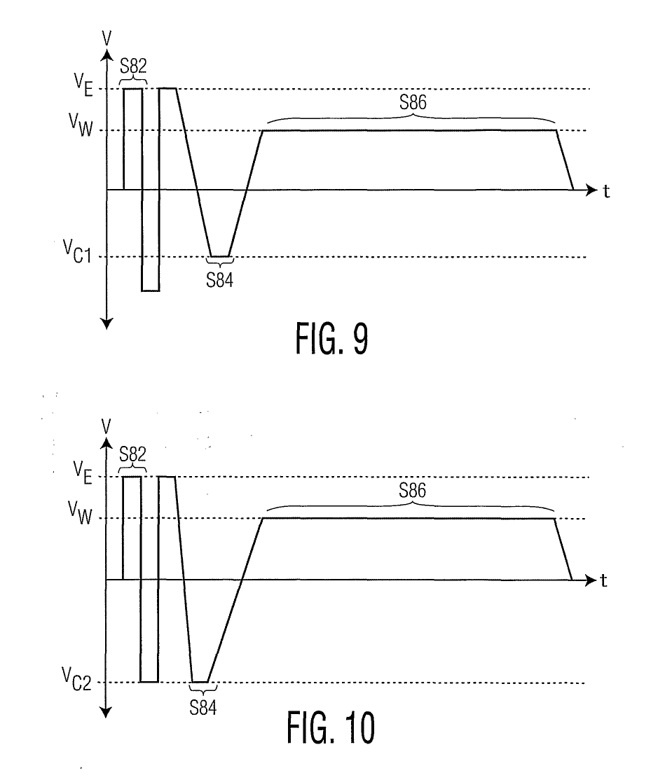

FIG. 9 illustrates an exemplary graphical representation of one embodiment in accordance of the present invention of a voltage amplitude modulation for revealing and

FIG. 10 illustrates an exemplary graphical representation of one embodiment in accordance of the present invention of a voltage slope modulation for revealing.

An electronic paint system 20 as illustrated in FIG. 1 employs a conventional monitor 30, a conventional computer 40, a conventional electronic brush 50, and a conventional controller 60 as will be appreciated by those having ordinary skill in the art. Electronic paint system 20 further employs a new and unique electronic ink stack 70 having embedded location codes exemplarily represented by the dashed circles shown in FIG. 1. The embedded location codes enable a user of system 20 to accurately produce an E-ink image on electronic ink stack 70 as will be further explained in connection with a subsequent description of FIG. 8 herein.

Each embodiment of electronic ink stack 70 in accordance with the present invention employs a front electrode, a back electrode and an electronic ink layer.

Each electrode is preferably fabricated from a reflective conductive material (e.g., aluminum, platinum, and chrome), or a transparent conductive material (e.g., indium tin oxide). The electronic ink layer is preferably one of several commercially available electrophoretic inks having thin electrophoretic film with millions of tiny microcapsules in which positively charged white particles and negatively charged black particles are suspended in a clear fluid.

Each embodiment of electronic ink stack 70 in accordance with the present invention can further employ a photoconductor layer (e.g.,) list examples of suitable material).

Location codes for electronic ink stack 70 are embedded within the front electrode, the back electrode, and/or the photoconductor layer (if employed.). In practice, the actual form, shape and dimensions of the location codes are dependent upon the intended commercial application of an embodiment of electronic ink stack 70. Thus, the inventors of the present invention do not impose any restrictions as to the form, shape and dimensions of the embedded location codes, and do not assert any “best form”, any “best shape” or any “best” dimensions of the embedded location codes. Furthermore, the inventors of the present invention do not imposes any restrictions as to the coding scheme implemented by the location codes.

FIGS. 2-7 illustrate three exemplary embodiments of electronic ink stack 70, which are not drawn to scale, but drawn to facilitate an understanding of the various principles of underlying the embedded location codes.

Referring to FIGS. 2 and 3, a first exemplary embodiment of electronic ink stack 70 employs a bottom electrode 71, a photoconductor layer 72, an electrophoretic ink layer 73, and a front electrode 74. Electronic ink stack 70 further employs embedded location codes in the form of insulation pads 75 disposed within photoconductor layer 72. Insulation pads 75 function as local resistors. Accordingly, an application of a voltage V as illustrated in FIG. 3 between electrodes 71 and 74 by controller 60 (FIG. 1) establishes a voltage drop across photoconductor layer 72 and electrophoretic ink layer 73 in areas of photoconductor layer 72 between insulation pads 75. Conversely, an application of the voltage V between electrodes 71 and 74 establishes a voltage drop across photoconductor layer 72, insulation pad 75, and electrophoretic ink layer 73 in areas of photoconductor layer 72 having insulation pads 75.

Referring to FIGS. 4 and 5, a second exemplary embodiment of electronic ink stack 70 employs bottom electrode 71, a photoconductor layer 76, electrophoretic ink layer 73, and a front electrode 74. Electronic ink stack 70 further employs embedded location codes in the form of indentations 77 within photoconductor layer 76.

Indentations 77 function to reduce the resistive strength of photoconductor layer 76 in areas of photoconductor layer 76 having indentations 77. Accordingly, an application of a voltage V as illustrated in FIG. 3 between electrodes 71 and 74 by controller 60 (FIG. 1) establishes a voltage drop across photoconductor layer 76 and electrophoretic ink layer 73 whereby the resistance to the voltage drop is greatest in areas of photoconductor layer 76 between indentations 77.

Referring to FIGS. 6 and 7, a third exemplary embodiment of electronic ink stack 70 employs bottom electrode 78, a photoconductor layer 72, electrophoretic ink layer 73, and a front electrode 74. Electronic ink stack 70 further employs embedded location codes in the form of holes 79 extending through back electrode 78. Accordingly, an application of a voltage V as illustrated in FIG. 6 between electrodes 78 and 74 by controller 60 (FIG. 1) establishes a voltage drop across photoconductor layer 72 and electrophoretic ink layer 73 whereby the resistance to the voltage drop is greatest in areas of photoconductor layer 72 and electrophoretic ink layer 73 where electrodes 78 and 74 overlap.

FIG. 8 illustrates a flowchart 80 representative of a method of producing various images in the exemplary embodiments of electronic ink stack 70 illustrated in FIGS. 2-7.

Referring to FIG. 8, a blank image in the form a black blank image 90 or a white blank image 91 is produced during a stage S82 of flowchart 80. In one embodiment of stage S82, as illustrated in FIGS. 9, the voltage V applied to the electrodes during stage S82 is in the form of erasing voltage pulse having a magnitude V_{E}+ for switching the electronic ink layer to an entirely black state to produce black blank image 90, or to an entirely white to produce white blank image 91.

In another embodiment, as illustrated in FIG. 10, the voltage V applied to the electrodes during stage S82 is in the form of an erasing voltage pulse having a magnitude V_{O}+ for switching the electrophoretic ink layer to entirely black or entirely white.

Referring again to FIG. 8, a coded image in the form a black coded image 92 or a white coded image 93 is produced during a stage S84 of flowchart 80. In one embodiment of stage S84, as illustrated in FIG. 9, the voltage V applied to the electrodes during stage S84 is in the form of coding voltage pulse having a magnitude V_{C1}− for switching areas of the electronic-eink layer corresponding to the embedded location codes, employing layer. The transition from the erasing voltage pulse V_{E}+ pulse to the coding voltage pulse V_{C1}− is appropriately sloped in FIG. 9 in as would be appreciated by one having ordinary skill in the art FIG. 9 to to thereby prevent all areas of the electronic ink layer from switching from black to white, or vice-versa.

In another embodiment of stage S84, as illustrated in FIG. 10, the voltage V applied to the electrodes during stage S84 is in the form of a coding voltage pulse having a magnitude V_{C2O}− for switching areas of the electronic ink layer corresponding to the embedded location codes. The transition from the erasing voltage V_{E}+ pulse to the coding voltage pulse V_{C1}− pulse is appropriately sloped in FIG. 10 to prevent all areas of the electronic ink layer from switching from black to white, or vice-versa. Furthermore, the slope of the FIG. 10 transition, which is greater than the slope of the FIG. 9 transition, achieves the switching areas of the electronic ink layer not corresponding to the embedded location codes although the absolute magnitude of the applied voltage V remain unchanged, location.

Referring again to FIG. 8, a pictorial image, such as, for example, a pictorial image 94 is produced during a stage S86 of flowchart 80. In embodiments of stage. S86, as illustrated in FIGS. 9 and 10, the voltage V applied to the electrodes during stage S86 is in the form of a writing voltage pulse having a magnitude voltage V_{W} that . Electronic brush 50 (FIG. 1) is utilized during stage S86 to create the appropriate grey levels within the pictorial image. To this end, electronic brush 50 is moved over the electronic ink stack whereby, after detection of location code, electronic brush 50 is operated to apply laser pulse(s) for creating the appropriate grey level(s) associated with the detected location codes. As known in the art, the creation of the appropriate grey level(s) is dependent upon the light intensity and/or pulse period of the laser pulse(s). As would be appreciated by those having ordinary skill in the art, t

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic ink stack (70), comprising:
a front electrode (74);
a back electrode (71, 78);
an layer (73) disposed between said front electrode (74) and said back electrode (71, 78); and
at least one location code (75, 77, 79) embedded within at least one of said front electrode (74) and said back electrode (71, 78).

2. The electronic ink stack (70) of claim 1,
wherein said electronic ink layer (73) includes an electrophoretic ink.

3. The electronic ink stack (70) of claim 1,
wherein a first location code is a hole (79) extending through said back electrode (78).

4. The electronic ink stack (70) of claim 1,
wherein a first location code is a hole (79) extending through said front electrode (74).

5. The electronic ink stack (70) of claim 1,
wherein an application of a coding voltage pulse between said front electrode (74) and said back electrode (71, 78) produces a coded image for revealing at least one location code (75, 77, 79).

6. The electronic ink stack (70) of claim 1,
wherein an implementation of a voltage amplitude modulation technique facilitates a sequential production of a blank image (90, 91), a coded image (92, 93) and a pictorial E-ink image (94) in said electronic ink layer (73).

7. The electronic ink stack (70) of claim 1,
wherein an implementation of a voltage slope modulation technique facilitates a sequential production of a blank image (90, 91), a coded image (92, 93) and a pictorial image (94) in said electronic ink layer (73).

8. The electronic ink stack (70) of claim 1, further comprising:
a photoconductor layer (72, 76) disposed between said front electrode (74) and said back electrode (71, 78).

9. The electronic ink stack (70) of claim 8,
wherein said least one location code (75, 77, 79) is embedded within at least one of said front electrode (74), said back electrode (71, 78) and said photoconductor layer (72, 76).

10. The electronic ink stack (70) of claim 9,
wherein a first location code is an insulation pad (75) disposed within said photoconductor layer (72, 76).

11. The electronic ink stack (70) of claim 9,
wherein a first location code is an indentation (77) in said photoconductor layer (72, 76).

12. An electronic ink system (20), comprising:
an electronic ink stack (70) including
a front electrode (74),
a back electrode (71, 78),
an electronic ink layer (73) disposed between said front electrode (74) and said back electrode (71, 78), and
at least one location code (75, 77, 79) embedded within at least one of said front electrode (74) and said back electrode (71, 78); and
a controllable voltage source (60) operable to apply voltages between said front electrode (74) and said back electrode (71, 78).

13. The electronic ink system (20) of claim 12,
wherein said electronic ink layer (73) includes an electrophoretic ink.

14. The electronic ink system (20) of claim 12,
wherein a first location code is a hole (79) extending through said back electrode (78).

15. The electronic ink system (20) of claim 12,
wherein a first location code is a hole (79) extending through said front electrode (74).

16. The electronic ink system (20) of claim 12,
wherein said controllable voltage source (60) is operable to apply a coding voltage pulse between said front electrode (74) and said back electrode (71, 78) to thereby produce a coded image for revealing the at least one location code (75, 77, 79).

17. The electronic ink system (20) of claim 12,
wherein said controllable voltage source (60) is operable to implement a voltage amplitude modulation technique to thereby facilitate a sequential production of a blank image (90, 91), a coded image (92, 93) and a pictorial image (94) in said electronic ink layer (73).

18. The electronic ink system (20) of claim 17, further comprising:
an electronic brush (50) operable in conjunction with said controllable voltage source (60) to produce the pictorial image in said electronic ink layer (73) as a function of the at least one location code (75, 77, 79).

19. The electronic ink system (20) of claim 12,
wherein said controllable voltage source (60) is operable to implement a voltage slope modulation technique to thereby facilitate a sequential production of a blank image (90, 91), a coded image (92, 93) and a pictorial image (94) in said electronic ink layer (73).

20. The electronic ink system (20) of claim 19, further comprising:
an electronic brush (50) operable in conjunction with said controllable voltage source (60) to produce the pictorial image in said electronic ink layer (73) as a function of the at least one location code (75, 77, 79).

21. The electronic ink system (20) of claim 12, wherein said electronic ink stack (70) further includes:
a photoconductor layer (72, 76) disposed between said front electrode (74) and said back electrode (71, 78).

22. The electronic ink system (20) of claim 21,
wherein said least one location code (75, 77, 79) is embedded within at least one of said front electrode (74), said back electrode (71, 78) and said photoconductor layer (72, 76).

23. The electronic ink system (20) of claim 22,
wherein a first location code is an insulation pad (75) disposed within said photoconductor layer (72, 76).

24. The electronic ink system (20) of claim 23,
wherein a first location code is (77) in said photoconductor layer (72, 76).
